(19) United States
(12) Patent Application Publication
(10) Pub. No.: US 2019/0060819 A1
(43) Pub. Date: Feb. 28, 2019

(54) Gas/Liquid Heat and Material Exchange in the Presence of Entrained Solids

(71) Applicants: Larry Baxter, Orem, UT (US); Aaron Sayre, Spanish Fork, UT (US)

(72) Inventors: Larry Baxter, Orem, UT (US); Aaron Sayre, Spanish Fork, UT (US)

(21) Appl. No.: 15/683,074

(22) Filed: Aug. 22, 2017

(51) Int. Cl. B01D 47/02; F28C 3/06; F28F 13/12

(52) U.S. Cl. CPC B01D 47/021; F28F 13/12; F28C 3/06

(57) ABSTRACT

A device and a method for contacting gases and liquids in the presence of entrained solids is disclosed. A vertical, cylindrical vessel of a first diameter with a bubbling apparatus is provided comprising an outer apparatus diameter, surrounded by an annular space, a height above the bottom of the vessel. The outer apparatus diameter is between ⅓ and ¾ of the first diameter. The height is less than ½ of the difference between the first diameter and the outer apparatus diameter. The carrier gas bubbles upward out of the bubbling apparatus. A fluid passing through the vessel transitions from turbulent, to laminar or transitional, back to turbulent flow due to the changes in flow path areas.

### FIELD OF THE INVENTION

This invention relates generally to gas/liquid heat and material exchange. More particularly, we are interested in gas/liquid heat and material exchange when solids are present or created.

### BACKGROUND

The ability to effectively separate components of gases and conduct heat exchange in gas/liquid heat exchange is detrimentally impacted by the presence of solids in the liquid. Solids have a tendency to deposit on or freeze to surfaces where reactions occur, temperatures change, or flow slows. Designs of gas/liquid heat exchangers are insufficient for these systems. A design able to handle the solids and maintain heat and material exchange efficiencies is required.

United States patent application number 20060047163, to Vreede, et al., teaches an optimized liquid-phase oxidation process. The process involves gas sparging upwards through a column, reacting to produce a solid, the slurry descending past the sparger and out the bottom of the column. The present disclosure differs from this prior art disclosure in that the sparger is not symmetric and is not sized to cause turbulent to transitional or laminar flow as slurry descends past the sparger, and back to transitional flow below the sparger. This prior art disclosure is pertinent and may benefit from the devices disclosed herein and is hereby incorporated for reference in its entirety for all that it teaches.

U.S. Pat. No. 3,785,779, to Koros, et al., teaches a gas liquid inlet distributor. The process involves gas and liquid sparging upwards through a column. The present disclosure differs from this prior art disclosure in that the sparger does not have a cylindrical top face, does not involve slurry, and even without slurry, the liquid does not descend downward past the sparger. This prior art disclosure is pertinent and may benefit from the devices disclosed herein and is hereby incorporated for reference in its entirety for all that it teaches.

### SUMMARY

A device and a method for contacting gases and liquids in the presence of entrained solids is disclosed. A vertical, cylindrical vessel is provided. The vessel is of a first diameter comprising an upper region, a lower region, and an intermediate region between the upper region and the lower region. The upper region comprises a fluid inlet and a gas outlet. The lower region comprises a fluid outlet. The intermediate region comprises an annular space outside a vertical, cylindrical bubbling apparatus. The bubbling apparatus comprises a gas inlet, a gas outlet, and an outer apparatus diameter. The gas outlet comprises a perforated surface of the bubbling apparatus. The outer apparatus diameter is between ⅓ and ¾ of the first diameter. A height of the lower region is less than ½ of the difference between the first diameter and the outer apparatus diameter. A carrier gas is passed into the bubbling apparatus through the gas inlet. The carrier gas bubbles through the perforated surface into the upper region. A fluid is passed into the vessel through the fluid inlet and is passed downward through the upper region at a first fluid velocity. The fluid contacts the carrier gas, resulting in the upper region having a first turbulent flow pattern. The fluid comprises a first entrained solid, entrains a component of the carrier gas as a second entrained solid, or a combination thereof. The fluid passes into the annular space, speeding up to a second fluid velocity, resulting in a transition from the first turbulent flow pattern to a laminar or transitional flow pattern. The fluid passes into the lower region, slowing down to a third fluid velocity, resulting in a transition from the laminar or transitional flow pattern to a second turbulent flow pattern. The fluid passes out of the lower region through the fluid outlet.

The perforated surface may comprise a bubble plate, a bubble tray, a sparger, or combinations thereof.

The Reynolds number of the upper region may be above 4000. The Reynolds number of the intermediate region may be between 300 and 600. The Reynolds number of the lower region may be above 4000.

The carrier gas may comprise combustion flue gas, syngas, producer gas, natural gas, steam reforming gas, any hydrocarbon that has a lower freezing point than the temperature of the coolant, light gases, refinery off-gases, or combinations thereof. The component of the carrier gas may comprise water, carbon dioxide, nitrogen oxide, sulfur dioxide, nitrogen dioxide, sulfur trioxide, hydrogen sulfide, hydrogen cyanide, hydrocarbons, or combinations thereof. The entrained solid may comprise water, carbon dioxide, nitrogen oxide, sulfur dioxide, nitrogen dioxide, sulfur trioxide, hydrogen sulfide, hydrogen cyanide, hydrocarbons with a freezing point above a temperature of the fluid, or combinations thereof. The fluid may further comprise any compound or mixture of compounds with a freezing point below the temperature at which the solid melts. The fluid may further comprise mercaptans, ionic liquids, salt solutions, hydrocarbons, or a combination thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A-D show a side view, a cutaway top view, and cutaway isometric views of a device for contacting gases and liquids in the presence of entrained solids.

FIG. 2 shows a cutaway isometric view of a device for contacting gases and liquids in the presence of entrained solids.

FIG. 3 shows a cutaway isometric view of a device for contacting gases and liquids in the presence of entrained solids.

FIG. 4 shows a method for contacting gases and liquids.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

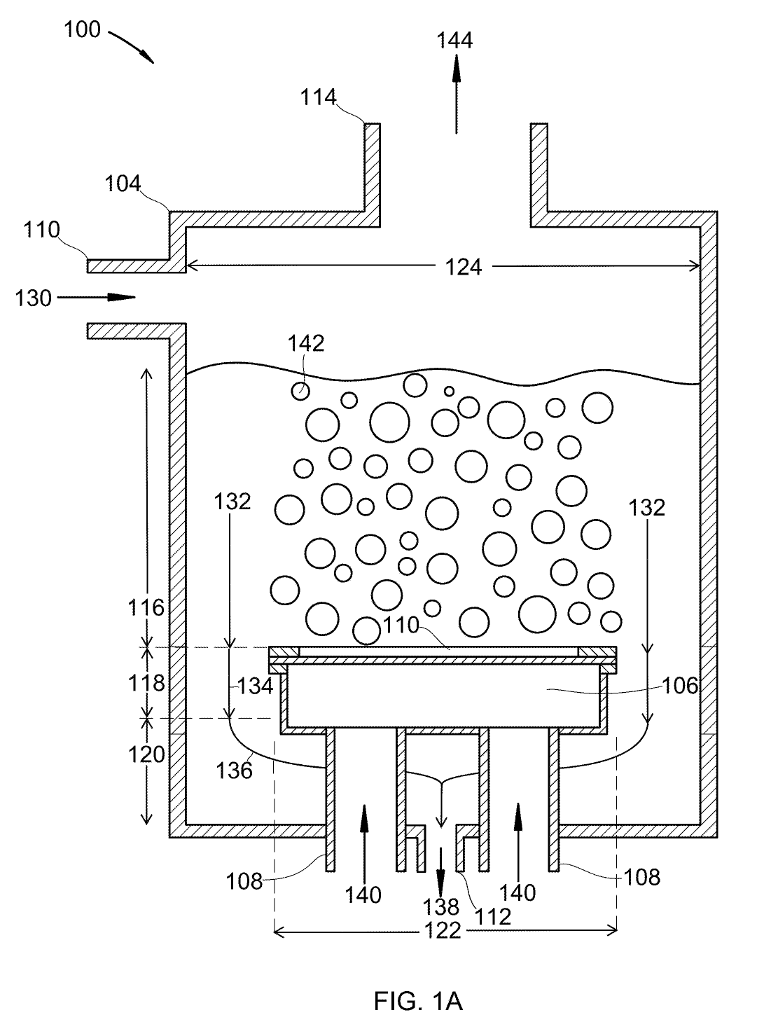

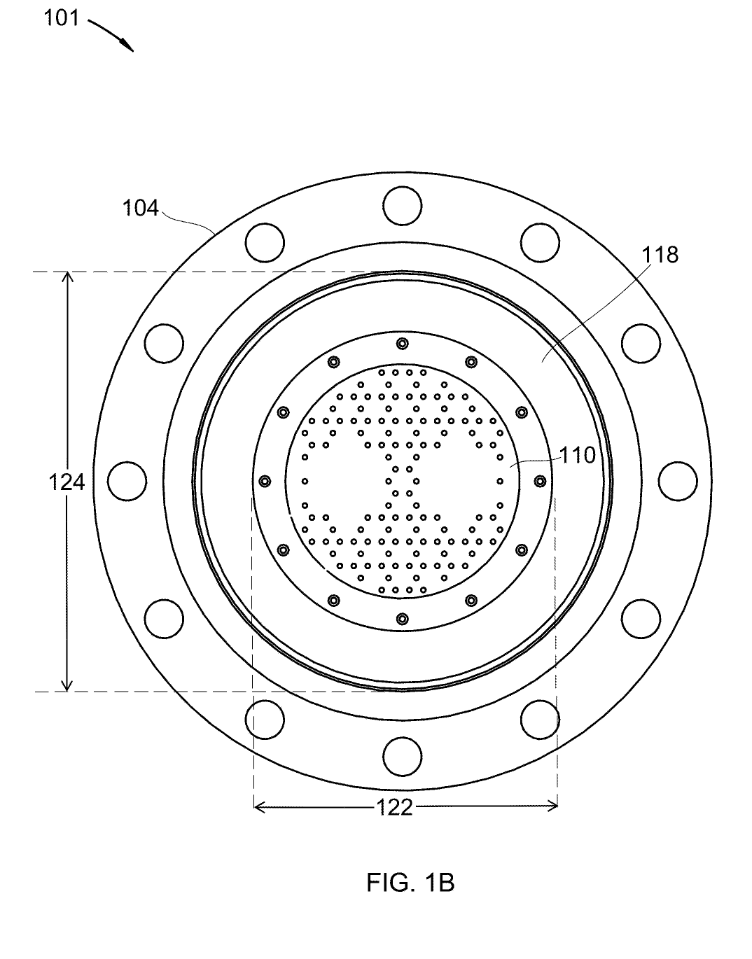

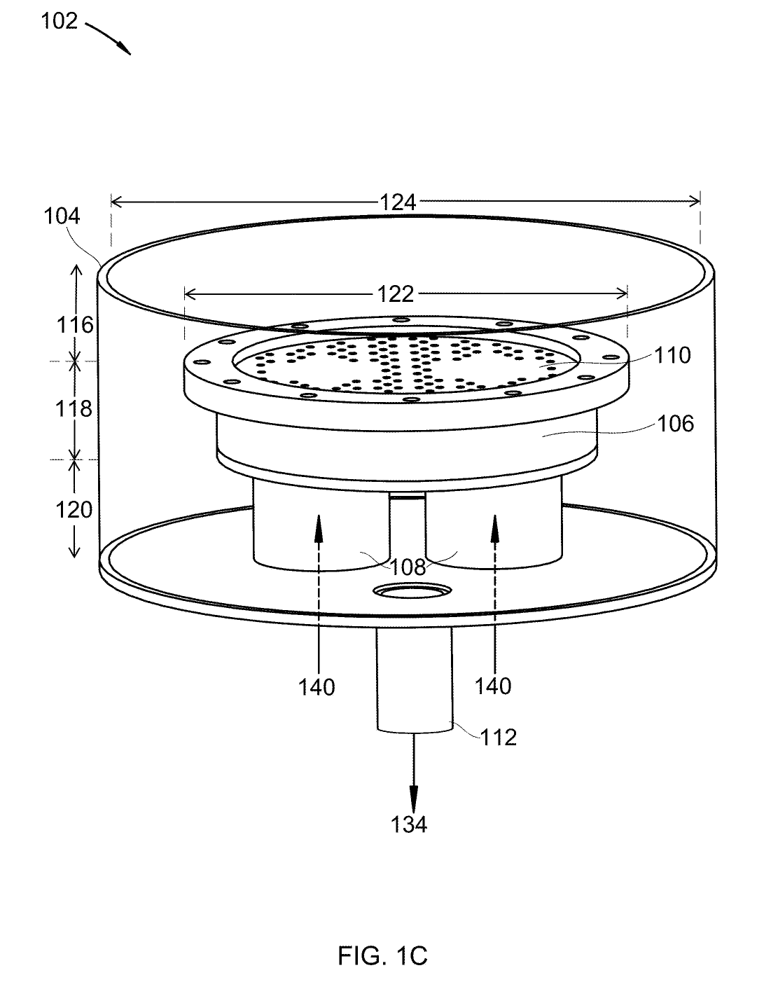

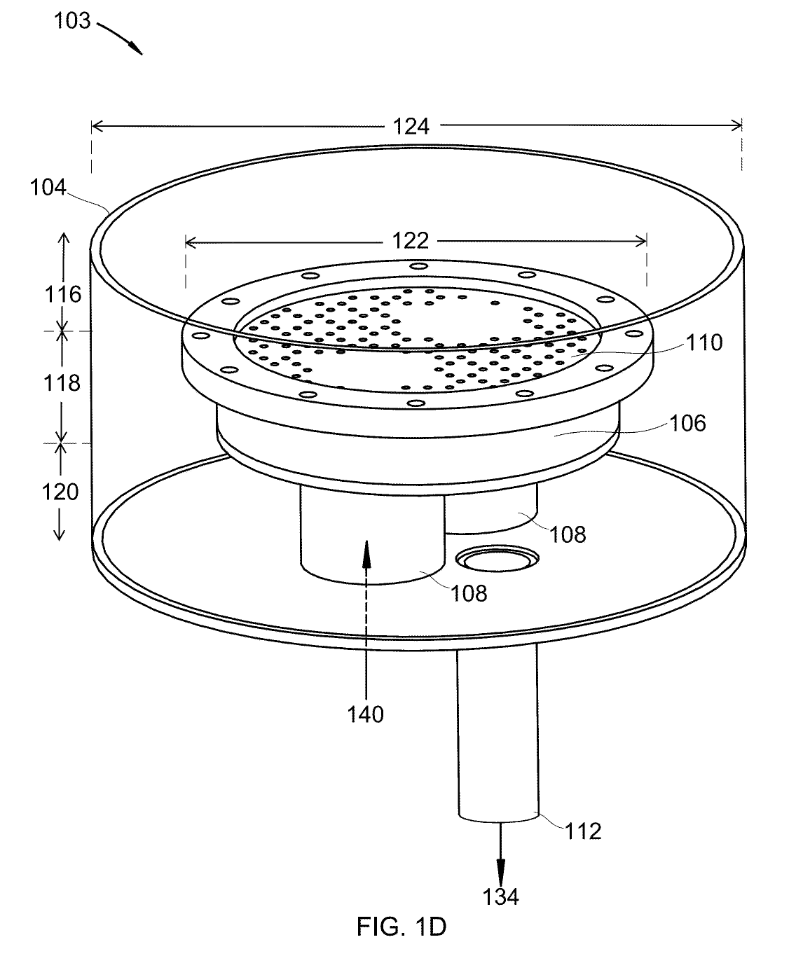

Referring to FIGS. 1A-D, a side view, a cutaway top view, and cutaway isometric views of a device for contacting gases and liquids in the presence of entrained solids is shown at 100-103, as per one embodiment of the present invention. Vertical, cylindrical vessel 104 comprises fluid inlet 110, gas outlet 114, fluid outlet 112, and bubbler apparatus 106. Vessel 104 is split into upper region 116, intermediate region 118, and lower region 120. Vessel 104 comprises first diameter 124. Bubbler apparatus 106 comprises gas inlets 112 and perforated bubble plate 110. Bubbler apparatus 106 comprises outer apparatus diameter 122. Intermediate region 118 is the annular space around bubbler apparatus 106. Outer apparatus diameter 122 is between ⅓ and ¾ of first diameter 124. The height of lower region 120 is less than ½ of the difference between first diameter 124 and outer apparatus diameter 122. Carrier gas 140 passes into bubbling apparatus 106 through gas inlet 108 and bubbles through the perforated surface of bubble plate 110 into upper region 116 as bubbles 142. Bubbles 142 pass out gas outlet 114 as stripped gas 144. Fluid 130 enters vessel 104 through fluid inlet 110 and passes downward as fluid 132 through upper region 116 at a first fluid velocity, contacting bubbles 142, resulting in upper region 116 having a first turbulent flow pattern, resulting in fluid 134. Fluid 134 passes into the annular space of intermediate region 118, fluid 134 speeding up to a second fluid velocity, resulting in a transition from the first turbulent flow pattern to a laminar or transitional flow pattern and fluid 136. Fluid 136 passes into the lower region and slows down to a third fluid velocity, resulting in a transition from the laminar or transitional flow pattern to a second turbulent flow pattern. Fluid 136 passes out of the lower region through the fluid outlet as fluid 138. This transitioning from turbulent to laminar or transitional and back to turbulent flow is of great benefit to flow of fluid through the system. Fluid 130 comprises a first entrained solid, entrains a component of the carrier gas as a second entrained solid, or a combination thereof. In either instance, fluid 130 is or becomes a slurry. Slurries have a tendency to deposit on or freeze to surfaces at the point of phase change, temperature change, or slow flow. Turbulent flow in upper region 116 prevents solids from depositing on or freezing to bubble plate 110. However, turbulent flow has a tendency to carry bubbles of gas with it. As such, transition of flow from turbulent to laminar is desirable to prevent gas bubbles from entraining and being drawn past the bubbler into fluids outlet 112. This transition is provided in intermediate region 118. The increase in flow velocity changes the flow pattern from turbulent to laminar or transitional. However, laminar and transitional flows in lower region 120 would lead to deposits of solids in lower region 120, eventually blocking flow in lower region 120. As such, the height of lower region 120 is set to cause the flow to transition back to turbulent flow in lower region 120. This allows solids to be drawn out of lower region 120 through fluid outlet 112.

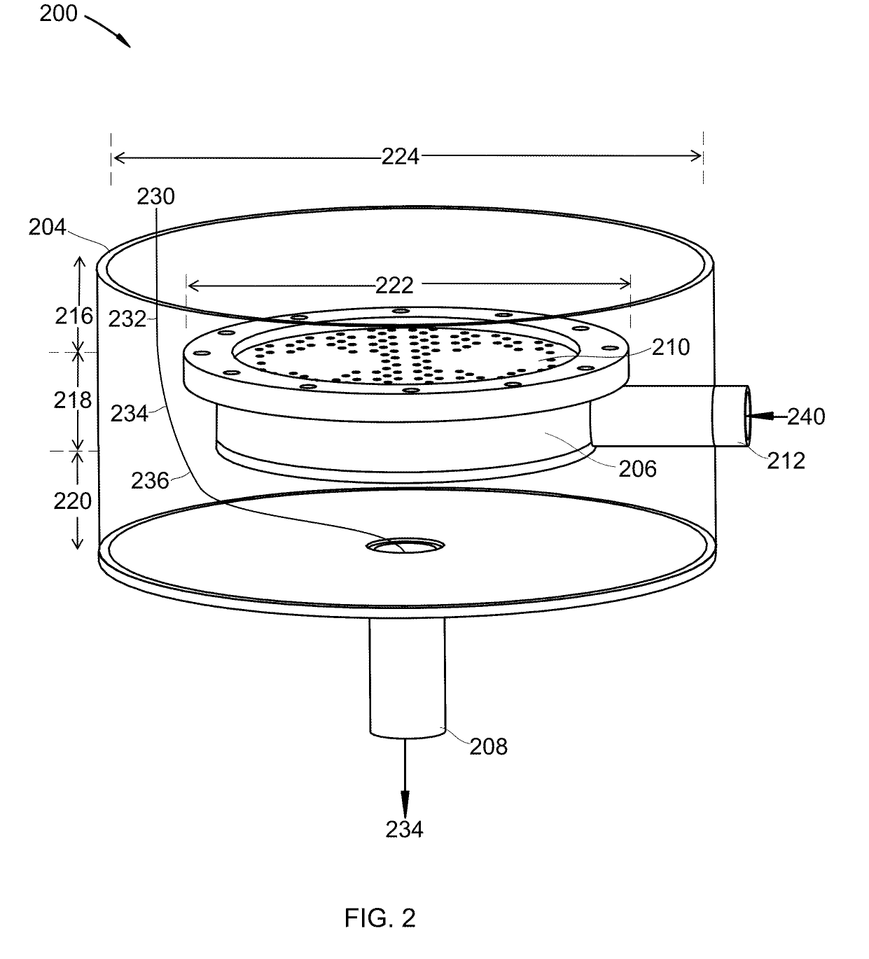

Referring to FIG. 2, a cutaway isometric view of a device for contacting gases and liquids in the presence of entrained solids is shown at 200, as per one embodiment of the present invention. The lower portion of a vertical, cylindrical vessel 204 comprises a fluid inlet (not shown), gas outlet (not shown), fluid outlet 212, and bubbler apparatus 206. Vessel 204 is split into upper region 216 (upper portion of upper region 216 not shown), intermediate region 218, and lower region 220. Vessel 204 comprises first diameter 224. Bubbler apparatus 206 comprises gas inlet 208 and perforated bubble plate 210. Bubbler apparatus 206 comprises outer apparatus diameter 222. Intermediate region 218 is the annular space around bubbler apparatus 206. Outer apparatus diameter 222 is between ⅓ and ¾ of first diameter 224. The height of lower region 220 is less than ½ of the difference between first diameter 224 and outer apparatus diameter 222. Carrier gas 240 passes into bubbling apparatus 206 through gas inlet 208 and bubbles through the perforated surface of bubble plate 210 into upper region 216 as bubbles 242. Bubbles 242 pass out gas outlet 214 as stripped gas 244. Fluid 230 enters vessel 204 through the fluid inlet and passes downward as fluid 232 through upper region 216 at a first fluid velocity, contacting bubbles 242, resulting in upper region 216 having a first turbulent flow pattern, resulting in fluid 234. Fluid 234 passes into the annular space of intermediate region 218, fluid 234 speeding up to a second fluid velocity, resulting in a transition from the first turbulent flow pattern to a laminar or transitional flow pattern and fluid 236. Fluid 236 passes into the lower region and slows down to a third fluid velocity, resulting in a transition from the laminar or transitional flow pattern to a second turbulent flow pattern. Fluid 236 passes out of the lower region through fluid outlet 208 as fluid 238. This transitioning from turbulent to laminar or transitional and back to turbulent flow is of great benefit to flow of fluid through the system. The fluid comprises a first entrained solid, entrains a component of the carrier gas as a second entrained solid, or a combination thereof. In either instance, fluid 230 is or becomes a slurry. Slurries have a tendency to deposit on or freeze to surfaces at the point of phase change, temperature change, or slow flow. Turbulent flow in upper region 216 prevents solids from depositing on or freezing to bubble plate 210. However, turbulent flow has a tendency to carry bubbles of gas with it. As such, transition of flow from turbulent to laminar is desirable to prevent gas bubbles from entraining and being drawn past the bubbler into fluids outlet 208. This transition is provided in intermediate region 218. The increase in flow velocity changes the flow pattern from turbulent to laminar or transitional. However, laminar and transitional flows in lower region 220 would lead to deposits of solids in lower region 220, eventually blocking flow in lower region 220. As such, the height of lower region 220 is set to cause the flow to transition back to turbulent flow in lower region 220. This allows solids to be drawn out of lower region 220 through fluid outlet 208.

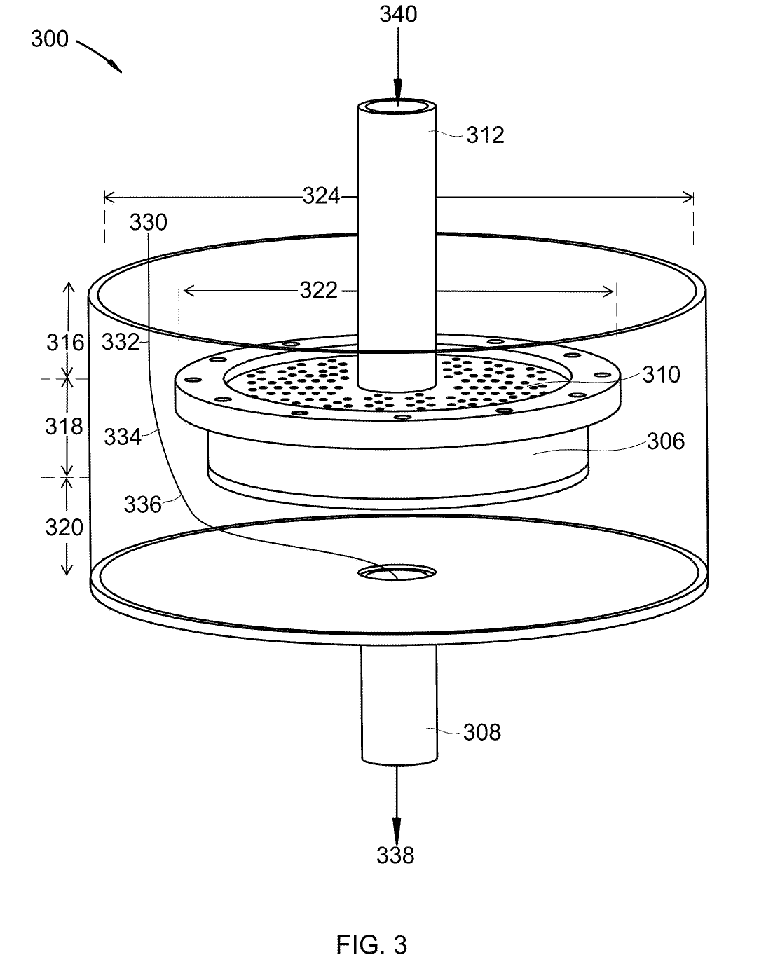

Referring to FIG. 3, a cutaway isometric view of a device for contacting gases and liquids in the presence of entrained solids is shown at 300, as per one embodiment of the present invention. The lower portion of a vertical, cylindrical vessel 304 comprises a fluid inlet (not shown), gas outlet (not shown), fluid outlet 312, and bubbler apparatus 306. Vessel 304 is split into upper region 316 (upper portion of upper region 316 not shown), intermediate region 318, and lower region 320. Vessel 304 comprises first diameter 324. Bubbler apparatus 306 comprises gas inlet 308 and perforated bubble plate 310. Bubbler apparatus 306 comprises outer apparatus diameter 322. Intermediate region 318 is the annular space around bubbler apparatus 306. Outer apparatus diameter 322 is between ⅓ and ¾ of first diameter 324. The height of lower region 320 is less than ½ of the difference between first diameter 324 and outer apparatus diameter 322. Carrier gas 340 passes into bubbling apparatus 306 through gas inlet 308 and bubbles through the perforated surface of bubble plate 310 into upper region 316 as bubbles 342. Bubbles 342 pass out gas outlet 314 as stripped gas 344. Fluid 330 enters vessel 304 through the fluid inlet and passes downward as fluid 332 through upper region 316 at a first fluid velocity, contacting bubbles 342, resulting in upper region 316 having a first turbulent flow pattern, resulting in fluid 334. Fluid 334 passes into the annular space of intermediate region 318, fluid 334 speeding up to a second fluid velocity, resulting in a transition from the first turbulent flow pattern to a laminar or transitional flow pattern and fluid 336. Fluid 336 passes into the lower region and slows down to a third fluid velocity, resulting in a transition from the laminar or transitional flow pattern to a second turbulent flow pattern. Fluid 336 passes out of the lower region through fluid outlet 308 as fluid 338. This transitioning from turbulent to laminar or transitional and back to turbulent flow is of great benefit to flow of fluid through the system. The fluid comprises a first entrained solid, entrains a component of the carrier gas as a second entrained solid, or a combination thereof. In either instance, fluid 330 is or becomes a slurry. Slurries have a tendency to deposit on or freeze to surfaces at the point of phase change, temperature change, or slow flow. Turbulent flow in upper region 316 prevents solids from depositing on or freezing to bubble plate 310. However, turbulent flow has a tendency to carry bubbles of gas with it. As such, transition of flow from turbulent to laminar is desirable to prevent gas bubbles from entraining and being drawn past the bubbler into fluids outlet 308. This transition is provided in intermediate region 318. The increase in flow velocity changes the flow pattern from turbulent to laminar or transitional. However, laminar and transitional flows in lower region 320 would lead to deposits of solids in lower region 320, eventually blocking flow in lower region 320. As such, the height of lower region 320 is set to cause the flow to transition back to turbulent flow in lower region 320. This allows solids to be drawn out of lower region 320 through fluid outlet 308.

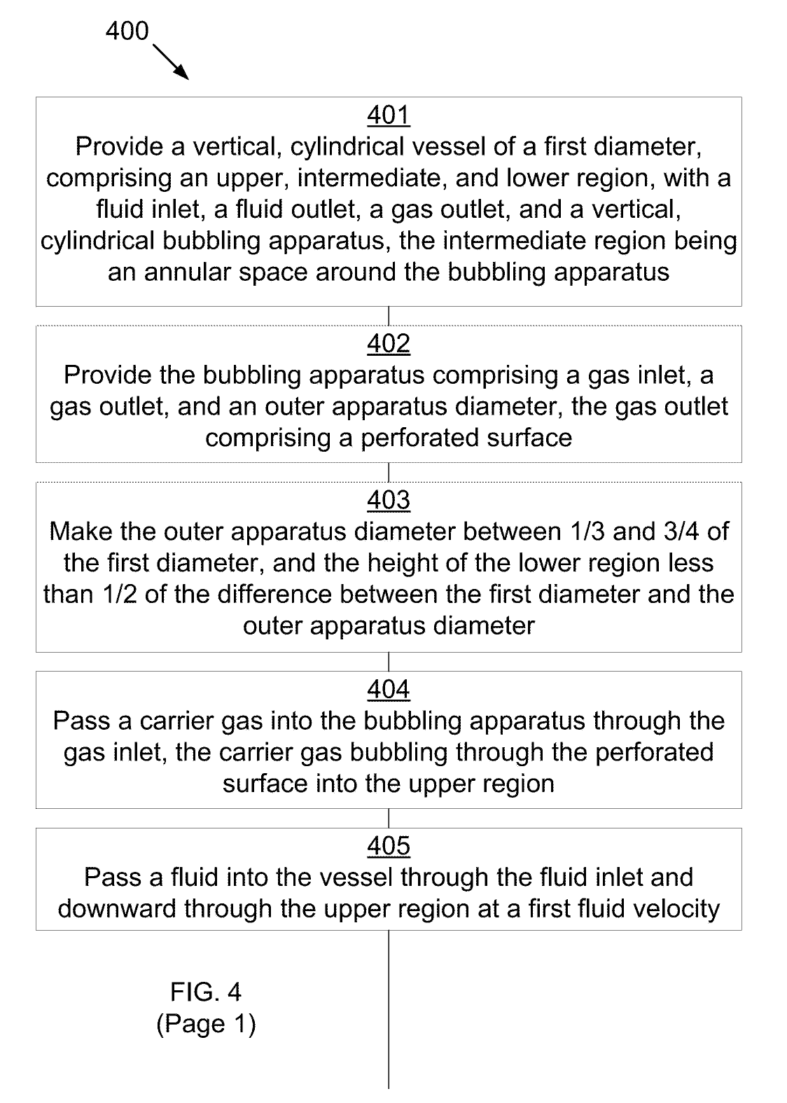

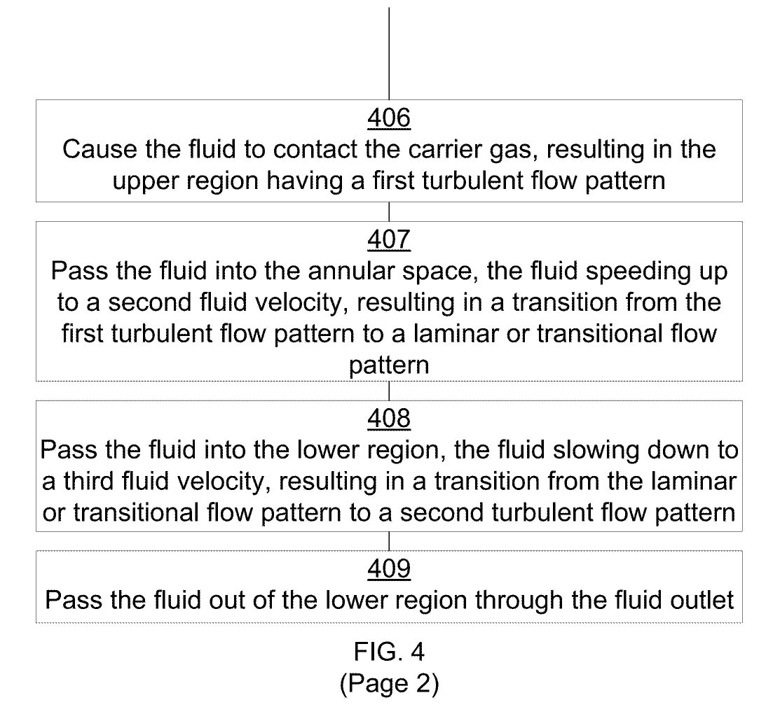

Referring to FIG. 4, a method for contacting gases and liquids is shown at 400, as per one embodiment of the present invention. A vertical, cylindrical vessel is provided of a first diameter comprising an upper region, a lower region, and an intermediate region between the upper region and the lower region, wherein the upper region comprises a fluid inlet and a gas outlet, the lower region comprises a fluid outlet, and the intermediate region comprises an annular space outside a vertical, cylindrical bubbling apparatus 401. The bubbling apparatus is provided comprising a gas inlet, a gas outlet, and an outer apparatus diameter, wherein the gas outlet comprises a perforated surface of the bubbling apparatus 402. The outer apparatus diameter is made to be between ⅓ and ¾ of the first diameter and a height of the lower region is made to be less than ½ of the difference between the first diameter and the outer apparatus diameter 403. A carrier gas is passed into the bubbling apparatus through the gas inlet, the carrier gas bubbling through the perforated surface into the upper region 404. A fluid is passed into the vessel through the fluid inlet and downward through the upper region at a first fluid velocity 405. The fluid contacts the carrier gas, resulting in the upper region having a first turbulent flow pattern 406. The fluid comprises a first entrained solid, entraining a component of the carrier gas as a second entrained solid, or a combination thereof. The fluid passes into the annular space, speeding up to a second fluid velocity, resulting in a transition from the first turbulent flow pattern to a laminar or transitional flow pattern 407. The fluid passes into the lower region, slowing down to a third fluid velocity, resulting in a transition from the laminar or transitional flow pattern to a second turbulent flow pattern 408. The fluid passes out of the lower region through the fluid outlet 409. This transitioning from turbulent to laminar or transitional and back to turbulent flow is of great benefit to flow of fluid through the system. The fluid comprises a first entrained solid, entrains a component of the carrier gas as a second entrained solid, or a combination thereof. In either instance, the fluid is or becomes a slurry. Slurries have a tendency to deposit on or freeze to surfaces at the point of phase change, temperature change, or slow flow. Turbulent flow in the upper region prevents solids from depositing on or freezing to the perforated surface. However, turbulent flow has a tendency to carry bubbles of gas with it. As such, transition of flow from turbulent to laminar is desirable to prevent gas bubbles from entraining and being drawn past the bubbling apparatus into the fluids outlet. This transition is provided in the annular space of the intermediate region. The increase in flow velocity changes the flow pattern from turbulent to laminar or transitional. However, laminar and transitional flows in the lower region would lead to deposits of solids in the lower region, eventually blocking flow in the lower region. As such, the height of the lower region is set to cause the flow to transition back to turbulent flow in the lower region. This allows solids to be drawn out of the lower region through the fluid outlet.

In some embodiments, the perforated surface comprises a bubble plate, a bubble tray, a sparger, or combinations thereof.

In some embodiments, the Reynolds number of the upper region is above 4000. In some embodiments, the Reynolds number of the intermediate region is between 300 and 600. In some embodiments, the Reynolds number of the lower region is above 4000.

In some embodiments, the carrier gas comprises combustion flue gas, syngas, producer gas, natural gas, steam reforming gas, any hydrocarbon that has a lower freezing point than the temperature of the coolant, light gases, refinery off-gases, or combinations thereof. In some embodiments, the component of the carrier gas comprises water, carbon dioxide, nitrogen oxide, sulfur dioxide, nitrogen dioxide, sulfur trioxide, hydrogen sulfide, hydrogen cyanide, hydrocarbons, or combinations thereof. In some embodiments, the entrained solid comprises water, carbon dioxide, nitrogen oxide, sulfur dioxide, nitrogen dioxide, sulfur trioxide, hydrogen sulfide, hydrogen cyanide, hydrocarbons with a freezing point above a temperature of the fluid, or combinations thereof.

In some embodiments, the fluid further comprises any compound or mixture of compounds with a freezing point below the temperature at which the solid melts. In some embodiments, the fluid further comprises mercaptans, ionic liquids, salt solutions, hydrocarbons, or a combination thereof.

Combustion flue gas consists of the exhaust gas from a fireplace, oven, furnace, boiler, steam generator, or other combustor. The combustion fuel sources include coal, hydrocarbons, and biomass. Combustion flue gas varies greatly in composition depending on the method of combustion and the source of fuel. Combustion in pure oxygen produces little to no nitrogen in the flue gas. Combustion using air leads to the majority of the flue gas consisting of nitrogen. The non-nitrogen flue gas consists of mostly carbon dioxide, water, and sometimes unconsumed oxygen. Small amounts of carbon monoxide, nitrogen oxides, sulfur dioxide, hydrogen sulfide, and trace amounts of hundreds of other chemicals are present, depending on the source. Entraine-d dust and soot will also be present in all combustion flue gas streams. The method disclosed applies to any combustion flue gases. Dried combustion flue gas has had the water removed.

Syngas Consists of Hydrogen, Carbon Monoxide, and Carbon Dioxide.

Producer gas consists of a fuel gas manufactured from materials such as coal, wood, or syngas. It consists mostly of carbon monoxide, with tars and carbon dioxide present as well.

Steam reforming is the process of producing hydrogen, carbon monoxide, and other compounds from hydrocarbon fuels, including natural gas. The steam reforming gas referred to herein consists primarily of carbon monoxide and hydrogen, with varying amounts of carbon dioxide and water.

Light gases include gases with higher volatility than water, including hydrogen, helium, carbon dioxide, nitrogen, and oxygen. This list is for example only and should not be implied to constitute a limitation as to the viability of other gases in the process. A person of skill in the art would be able to evaluate any gas as to whether it has higher volatility than water.

Refinery off-gases comprise gases produced by refining precious metals, such as gold and silver. These off-gases tend to contain significant amounts of mercury and other metals.

In some embodiments, the hydrocarbons comprise 1,1,3-trimethylcyclopentane, 1,4-pentadiene, 1,5-hexadiene, 1-butene, 1-methyl-1-ethyl cyclopentane, 1-pentene, 3,3,3,3-tetrafluoropropene, 3,3-dimethyl-1-butene, 3-chloro-1,1,1,2-tetrafluoroethane, 3-methylpentane, 3-methyl-1,4-pentadiene, 3-methyl-1-butene, 3-methyl-1-pentene, 3-methylpentane, 5-methyl-1-hexene, trifluoromethyl ether, 5-methyl-1-pentene, 5-methylcyclopentene, 5-methyl-trans-2-pentene, bromochlorodifluoromethane, bromodifluoromethane, dimethyl ether, ethyl fluoride, bromotrifluoroethylene, chlorotrifluoroethylene, cis 3-hexene, cis-1,3-pentadiene, cis-2-hexene, cis-2-pentene, dichlorodifluoromethane, difluoromethyl ether, ethyl mercaptan, hexafluoropropylene, isobutane, isobutene, isobutyl mercaptan, isopentane, isoprene, methyl isopropyl ether, methylcyclohexane, methylcyclopentane, methylcyclopropane, n,n-diethylmethylamine, octafluoropropane, pentafluoroethyl trifluorovinyl ether, propane, sec-butyl mercaptan, trans-2-pentene, trifluoromethyl trifluorovinyl ether, vinyl chloride, bromotrifluoromethane, chlorodifluoromethane, dimethyl silane, ketene, methyl silane, perchloryl fluoride, propylene, vinyl fluoride, methanol, ethanol, 1-propanol, 2-propanol, aqueous mixtures thereof, or combinations thereof.

1. A device for contacting gases and liquids in the presence of entrained solids comprising:
a vertical, cylindrical vessel of a first diameter comprising an upper region, a lower region, and an intermediate region between the upper region and the lower region, wherein the upper region comprises a fluid inlet and a gas outlet, the lower region comprises a fluid outlet, and the intermediate region comprises an annular space outside a vertical, cylindrical bubbling apparatus;
the bubbling apparatus comprising a gas inlet, a gas outlet, and an outer apparatus diameter, wherein the gas outlet comprises a perforated surface of the bubbling apparatus;
the outer apparatus diameter being between ⅓ and ¾ of the first diameter and a height of the lower region being less than ½ of the difference between the first diameter and the outer apparatus diameter.

2. The device of claim 1, wherein the perforated surface comprises a bubble plate, a bubble tray, a sparger, or combinations thereof.

3. The device of claim 1, wherein:
a carrier gas passes into the bubbling apparatus through the gas inlet and bubbles through the perforated surface into the upper region, the carrier gas passing through the upper region and out of the gas outlet;
a fluid passes into the vessel through the fluid inlet and passes downward through the upper region at a first fluid velocity, contacting the carrier gas, resulting in the upper region having a first turbulent flow pattern, the fluid comprising a first entrained solid, entraining a component of the carrier gas as a second entrained solid, or a combination thereof, the first turbulent flow pattern preventing deposition or freezing of the first or second entrained solids onto a surface of the bubbling apparatus or a surface of the vessel;
the fluid passes into the annular space, the fluid speeding up to a second fluid velocity, resulting in a transition from the first turbulent flow pattern to a laminar or transitional flow pattern, the laminar or transitional flow patterns preventing entrainment of the bubbles in the fluid;
the fluid passes into the lower region, the fluid slowing down to a third fluid velocity, resulting in a transition from the laminar or transitional flow pattern to a second turbulent flow pattern, the second turbulent flow pattern preventing deposition of solids onto the surface of the vessel; and,
the fluid passes out of the lower region through the fluid outlet.

4. The device of claim 3, wherein the Reynolds number of the upper region is above 4000.

5. The device of claim 4, wherein the Reynolds number of the intermediate region is between 300 and 600.

6. The device of claim 5, wherein the Reynolds number of the lower region is above 4000.

7. The device of claim 2, wherein the carrier gas comprises combustion flue gas, syngas, producer gas, natural gas, steam reforming gas, any hydrocarbon that has a lower freezing point than the temperature of the coolant, light gases, refinery off-gases, or combinations thereof.

8. The device of claim 7, wherein the component of the carrier gas comprises water, carbon dioxide, nitrogen oxide, sulfur dioxide, nitrogen dioxide, sulfur trioxide, hydrogen sulfide, hydrogen cyanide, hydrocarbons, or combinations thereof.

9. The device of claim 2, wherein the entrained solid comprises water, carbon dioxide, nitrogen oxide, sulfur dioxide, nitrogen dioxide, sulfur trioxide, hydrogen sulfide, hydrogen cyanide, hydrocarbons with a freezing point above a temperature of the fluid, or combinations thereof.

10. The device of claim 2, wherein the fluid further comprises any compound or mixture of compounds with a freezing point below the temperature at which the solid melts.

11. The device of claim 10, wherein the fluid further comprises mercaptans, ionic liquids, salt solutions, hydrocarbons, or a combination thereof.

12. A method for contacting gases and liquids comprising:
providing a vertical, cylindrical vessel of a first diameter comprising an upper region, a lower region, and an intermediate region between the upper region and the lower region, wherein the upper region comprises a fluid inlet and a gas outlet, the lower region comprises a fluid outlet, and the intermediate region comprises an annular space outside a vertical, cylindrical bubbling apparatus;
providing the bubbling apparatus comprising a gas inlet, a gas outlet, and an outer apparatus diameter, wherein the gas outlet comprises a perforated surface of the bubbling apparatus, wherein the outer apparatus diameter is between ⅓ and ¾ of the first diameter and a height of the lower region is less than ½ of the difference between the first diameter and the outer apparatus diameter;
passing a carrier gas into the bubbling apparatus through the gas inlet and bubbling the carrier gas through the perforated surface into the upper region;
passing a fluid into the vessel through the fluid inlet and downward through the upper region at a first fluid velocity, the fluid contacting the carrier gas, resulting in the upper region having a first turbulent flow pattern, the fluid comprising a first entrained solid, entraining a component of the carrier gas as a second entrained solid, or a combination thereof;
passing the fluid into the annular space, the fluid speeding up to a second fluid velocity, resulting in a transition from the first turbulent flow pattern to a laminar or transitional flow pattern;
passing the fluid into the lower region, the fluid slowing down to a third fluid velocity, resulting in a transition from the laminar or transitional flow pattern to a second turbulent flow pattern;
passing the fluid out of the lower region through the fluid outlet.

13. The method of claim 12, providing the perforated surface comprising a bubble plate, a bubble tray, a sparger, or combinations thereof.

14. The method of claim 12, wherein the Reynolds number of the upper region is above 4000.

15. The method of claim 14, wherein the Reynolds number of the intermediate region is between 300 and 600.

16. The method of claim 15, wherein the Reynolds number of the lower region is above 4000.

17. The method of claim 12, providing the carrier gas comprising combustion flue gas, syngas, producer gas, natural gas, steam reforming gas, any hydrocarbon that has a lower freezing point than the temperature of the coolant, light gases, refinery off-gases, or combinations thereof.

18. The method of claim 17, providing the component of the carrier gas and the entrained solid each comprising water, carbon dioxide, nitrogen oxide, sulfur dioxide, nitrogen dioxide, sulfur trioxide, hydrogen sulfide, hydrogen cyanide, hydrocarbons with a freezing point above a temperature of the fluid, or combinations thereof.

19. The method of claim 12, providing the fluid further comprising any compound or mixture of compounds with a freezing point below the temperature at which the solid melts.

20. The method of claim 19, providing the fluid further comprising mercaptans, ionic liquids, salt solutions, hydrocarbons, or a combination thereof.
